(19) United States
(12) Patent Application Publication
(10) Pub. No.: US 2008/0170778 A1
(43) Pub. Date: Jul. 17, 2008

(54) METHOD AND SYSTEM FOR DETECTION AND REMOVAL OF REDEYES

(76) Inventor: HUITAO LUO, Fremont, CA (US)

Correspondence Address: Huitao Luo, 48043 Leontine CT, Fremont, CA, 94539, US

(21) Appl. No.: 11/623,239

(22) Filed: Jan. 15, 2007

(51) Int. Cl. G06K 9/34; G06K 9/00

(52) U.S. Cl. 382/164; 382/165

(57) ABSTRACT

Systems and methods for detecting and correcting redeye defects in a digital image are described. In one aspect, the invention proposes a color image segmentation method. In accordance with this method, pixels of the input image are segmented by mapping the pixels to a color space and using a number of segmentation surfaces defined in the color space. Based on segmentation results, candidate redeye pixel regions are further identified. In another aspect, the invention features a method to classify candidate redeye pixel regions into redeye pixel regions and non-redeye pixel regions. In accordance with this method, the candidate redeye pixel regions are processed by a cascade of classification stages. In each classification stage, a plural of attributes are computed for the input candidate redeye pixel region to define a feature vector. The feature vector is feed to a pre-trained binary classifier. A candidate redeye pixel region that passes a classification stage is further processed by a next classification stage, while a region that fails is rejected and dropped from further processing. Only the candidate redeye pixel regions that pass all the classification stages are identified as the redeye pixel regions. In another aspect, the invention describes a set of attributes that are effective in driving classification of redeye pixel regions from non-redeye pixel regions. The invention also describes a scheme to generate a plural of attributes and a machine learning scheme to select best attributes for classification design purpose.

### BACKGROUND

Redeye is a common problem in consumer photography. It is caused by flash light reflecting by the blood vessels in people's retina and returning to the camera, which contributes directly to unnatural redness appearance of the pupil. With the popularity of digital photograph and continued shrinking in camera sizes, redeye artifact is becoming one of the top problems that consumers would like to address in this area.

Many different methods have been invented to reduce or remove redeye artifacts. One common approach is to use some pre-exposure flash to reduce people's pupils. It is known that this works for some people in some occasions, but fail in other cases. In addition, pre-flash is annoying for some people and costs extra battery power.

Many digital processing methods have also been proposed to remove redeye artifacts by processing digital photos after photo taken stage. They normally comprise of two steps: a detection step to identify the redeyes and a correction step to remove the redeyes. Based on how their redeye detection step is designed, most digital processing methods in the art could be classified into three categories: manual methods, semi-automatic methods, and automatic methods.

In manual methods, the redeye detection step is carried out total manually by the user. Through operating with different editing tools, a user specifies the location of the red eyes with accuracy to pixel level. A redeye removal step is further applied to map the detected redeye pixels to normal color, often through desaturation. A typical example of this is to do redeye removal by using Adobe Systems Inc's Photoshop. Many articles have been published to teach people how to remove redeye by using editing tools provided by Photoshop. Apparently manual methods have the potential to provide high quality results, however, they are not convenient to use and requires one know extensively regarding image editing and image processing, and thus are not a good solution for general people.

Semi-automatic methods provide better user experience in that a user only provides hints in redeye detection step by either clicking on or close to the redeye or specifying a rectangle that contains the redeye. A computer program will then find the exact redeye location to the pixel level based on user provided hints. A redeye correction step is further applied with or without user intervention. Semi-automatic methods have been popular in many image editing software programs in the market. Some authors refer to these methods as “automatic” methods in order to emphasize their difference from manual methods. Adobe Systems Inc's PhotoDeluxe and Microsoft Corporation's Picture IT are two photo editing software applications that offer semi-automatic redeye removal solutions.

Several patents known in the art have disclosed semi-automatic redeye removal methods, such as U.S. Pat. No. 6,016,345 to Lin et al. (issued on Jan. 18, 2000), U.S. Pat. No. 7,008,855 to Adolfo Pinheiro Vide (issued on Aug. 8, 2006), and U.S. Pat. No. 6,980,691 to V. Nesterov et al. (issued on Dec. 27, 2005).

Automatic redeye removal methods provide even better user experience by removing user intervention from both redeye detection step and redeye correction step. In addition, automatic redeye removal methods are appropriate for processing photos on devices such as cameras, cellular phones and printers because means of user intervention is limited on these platforms as compared with desktop computers. Accordingly, automatic redeye removal methods are gaining more attention and they are also the main area this invention is to discuss further.

In the art, one common design for automatic redeye removal methods is to use some face detection algorithm to find potential face regions and then look for redeyes from within the face regions. U.S. patent application Ser. No. 10/131173 describes a method that is based on face detection. U.S. patent application Ser. No. 10/082458 describes a face detection method that is base on skin tone region detection and camera meta data information, it also claims automatic redeye detection and removal as a direct application of face detection method.

The main limitation for face detection based methods, however, is that their performance is highly dependant on the quality of the underlining face detection method. It is known that most face detection methods in the art detect faces in upright frontal view positions, but are likely to miss faces with in-plane and out-of-plane rotations. In addition, most known face detection methods in the art are computationally complex and are not appropriate for embedded platforms such as cameras and printers. All these facts pose limitations on the performance and applications of the corresponding redeye removal methods.

Alternatively, several patents known in the art have disclosed methods to do automatic redeye removal without face detection.

U.S. Pat. No. 6,292,574 to Jay Schildkraut et al. (issued on Sep. 18, 2001) proposed a method that is based on skin tone detection. This method starts by searching an entire digital image for detecting one or more skin colored regions. The skin color regions are verified by testing their attributes such as shape, aspect ratio, etc. against a number of thresholds to ensure that they have a characteristic of a face. Each verified skin colored region is resized based on one or more predetermined facial dimensions to form one or more resized skin colored regions. Further searching is carried out within the resized skin colored regions for groups of pixels with color characteristic of redeye defect.

A recent U.S. Pat. No. 6,873,743 issued to Eran Steinberg on Mar. 29, 2005 describes a method that is based on color image segmentation. The input color image is first segmented into segments based on a color chrominance component and a luminance component. The image segments are then processed by a number of eliminating stages. In each stage, some testing is applied to check if certain attribute of the segment exceeds some pre-determined threshold. Anything that survive the eliminating stages are accepted as redeyes and are further processed by a color correction module to remove the redeye.

Both methods described in U.S. Pat. No. 6,292,574 and U.S. Pat. No. 6,873,743 adopt the common principle of looking for some candidates by initially applying only partial attributes of redeye regions, and then refining the candidates by imposing additional attributes testing in several stages. A more recent U.S. Pat. No. 7,116,820 issued to Huitao Luo et al. on Oct. 3, 2006 proposes a method following similar principle except that a different initial candidate detection algorithm and different sets of attributes are used for refining stages.

Although the aforementioned patents U.S. Pat. Nos. 6,292,574, 6,873,743 and 7,116,820 have different strength and weakness in their respective designs, a common problem they share is that their attribute testing stages are mainly designed through ad hoc approach and it is difficult to find optimal parameter setting of these multiple testing stages in the global performance sense. It is more desirable to design the refining stages using machine learning based classification technology to achieve better performance.

In addition to classification technology, different designs of attributes also play important role in determining redeye detection performance, not only with regard to detection rate and false alarm rate, but also the overall system complexity. For example, some attributes like redness attribute have better discriminating power than others like skin tone attribute, and some attributes may have more concentrated statistical distribution than others for redeye problem. Although the aforementioned patents have described many good attributes for redeye problem, it is desirable to utilize systematical machine learning technology to design new attributes and to find the optimal combination of them for redeye detection purpose.

The present invention comes up with a novel automatic redeye removal method that solves many problems mentioned above.

### SUMMARY OF THE INVENTION

In one aspect, the invention proposes a color image processing method. In accordance with this method, pixels of the input image are segmented by mapping the pixels to a color space and then partitioning the color space using a number of segmentation surfaces. Based on segmentation results, candidate redeye pixel regions are further identified.

In another aspect, the invention features an efficient method to reject non-redeye pixel regions from candidate redeye pixel regions. In accordance with this method, the candidate redeye pixel regions are processed by a cascade of classification stages. In each classification stage, a plural of attributes are computed for the input candidate redeye pixel region to define a feature vector. The feature vector is feed to a pre-trained classifier. A candidate redeye pixel region that passes a classification stage is further processed by a next classification stage, while a region that fails is rejected and dropped from further processing. Only the candidate redeye pixel regions that pass all the classification stages are identified as the redeye pixel regions.

In another aspect, the invention describes a set of attributes that are effective in driving classification of redeye pixel regions from non-redeye pixel regions. The invention also describes a scheme to generate a plural of attributes and a machine learning scheme to select best attributes for classification design purpose.

### BRIEF DESCRIPTION OF THE DRAWINGS

Features of the present invention will become apparent to those skilled in the art from the following description with reference to the figures, in which:

FIG. 1 is a block diagram of an embodiment of a system for detecting and correcting redeye defects in a digital image;

FIG. 2 is a block diagram of components of an embodiment of a redeye detection module;

FIG. 3A is a block diagram of components of an embodiment of a redeye candidate detection module;

FIG. 3B is a view showing a candidate redeye pixel region represented by a containing rectangle and a support map;

FIG. 4 is a view showing a neighborhood definition with respect to the containing rectangle of a candidate redeye pixel region;

FIG. 5A is a block diagram of an embodiment of initialization module that computes an initial segmentation surface based on a set of labeled training images;

FIG. 5B is a block diagram of an embodiment of a refining module that refines a segmentation surface using a plural of verification images;

FIG. 6 is a three-dimensional plot of approximating a segmentation surface in RGB color space using a plural of sampling points defined with evenly quantization along R and B axes;

FIG. 7 is a block diagram of an embodiment of a redeye candidate detection module that uses two separate segmentation surfaces;

FIG. 8A is a block diagram of an embodiment of a redeye verification module;

FIG. 8B is a block diagram of an embodiment of a redeye verification module that is based on a cascade architecture;

FIG. 9A is a block diagram of an embodiment of a training procedure to build a cascade architecture for a redeye verification module;

FIG. 9B is a block diagram of an embodiment of an attribute computation module used in a training procedure for building a cascade architecture.

FIG. 10A is a block diagram of an embodiment of a processing procedure used to compute chrominance attribute group, linear redness attribute group and texture attribute group;

FIG. 10B is a view showing a neighborhood template defined with respect to a base rectangle;

FIG. 10C is a view showing a circular neighborhood template defined with respect to a base rectangle;

FIG. 10D is a view showing a scalable search template used to identify a base rectangle for computing texture attribute group; and

FIG. 11 is a block diagram of an embodiment of a redeye correction module;

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

### I. System Overview

Referring to FIG. 1, in one embodiment, a redeye removal system 100 is comprised of two function modules, a redeye detection module 102 and a redeye correction module 104. The redeye detection module 102 processes an input image 106 and automatically identifies redeye pixel regions 108. The redeye correction module 104 further processes the detected redeye pixel regions to generate a corrected image 110.

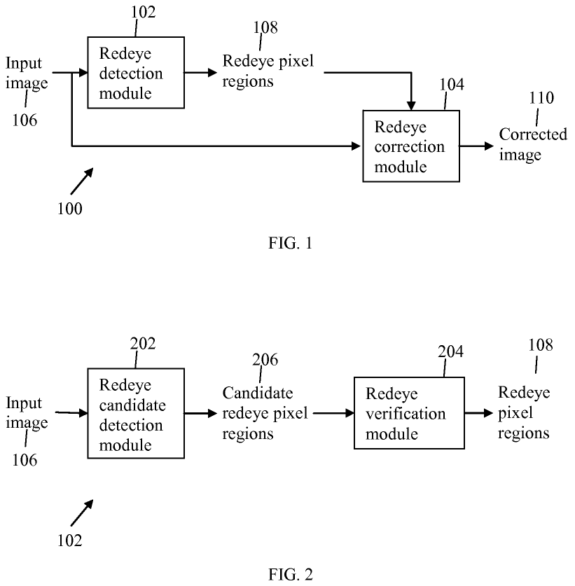

Referring to FIG. 2, in one embodiment, a redeye detection module 102 is comprised of a redeye candidate detection module 202 and a redeye verification module 204. The redeye candidate detection module 202 detects candidate redeye pixel regions 206 from the input image 106. The redeye verification module 204 further processes the candidate redeye pixel regions 206 to remove non-redeye pixel regions (false alarms) and generates redeye pixel regions 108.

In general, a redeye removal system 100 may be implemented in any computing and/or processing environments, including but not limited to computer software, firmware, device driver, digital electronic circuitry or computer hardware, or any combination of these. In one embodiment, a redeye removal system 100 is implemented as firmware on devices such as digital cameras, PDAs and Cellular phones to enable on-device, automatic redeye removal function. In another embodiment, some components of a redeye removal system 100 are implemented in digital electronic circuitry, and the others are implemented in firmware. In another embodiment, a redeye removal system 100 is implemented in a printer driver to enable redeye removal function for photo printers. In still another embodiment, a redeye removal system 100 is implemented as web service on a web server. Users could upload digital photos to the web server and have the redeye automatically removed.

### II. Redeye Detection Module

FIG. 2 shows an exemplary block diagram of an embodiment of a redeye detection module. Input image 106 is first processed by redeye candidate detection module 202 to generate candidate redeye pixel regions 206. Candidate redeye pixel regions 206 are further processed by redeye verification module 204 to reject false alarms and produces redeye pixel regions 108.

### A. Redeye Candidate Detection Module

Redeye candidate detection module processes an input color image to identify a number of candidate redeye pixel regions. The candidate redeye pixel regions are identified through imposing only partial features of redeyes. Since only partial features are imposed, the detected pixel regions are only redeye candidates, but not the final redeyes.

In one embodiment, the partial feature used to design redeye candidate detection module is redness feature. In other words, the redeye candidate detection module is designed to find all the pixels that are considered red enough, or much redder than their neighboring pixels.

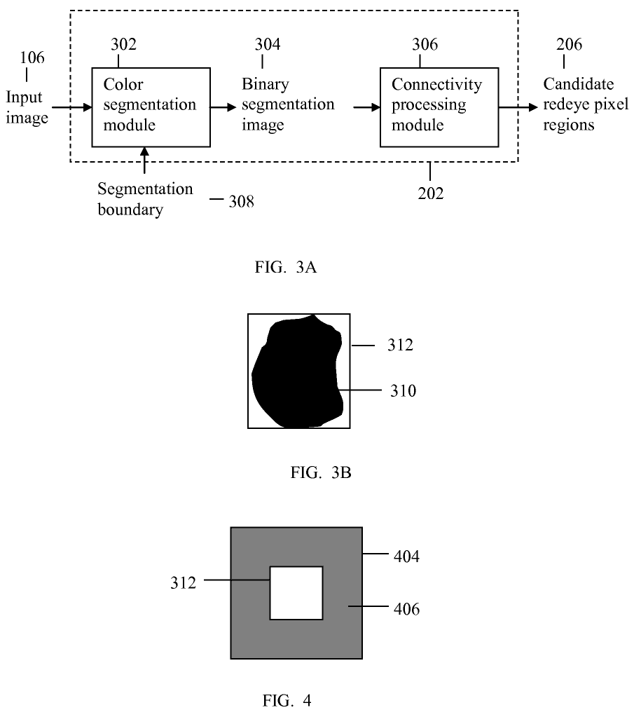

FIG. 3A shows an embodiment of a redeye candidate detection module 202. Input image 106 is first processed by a color segmentation module 302 that converts 106 into a binary segmentation image 304. The binary segmentation image is further processed by a connectivity processing module 306 to group binary image pixels into candidate redeye pixel regions 206 based on pixel connectivity.

FIG. 3B shows a candidate redeye pixel region represented by a support binary map 310 and a containing rectangle 312. Note the support map represents the identified redeye pixels with “1”s and background pixels with “0”s. And the containing rectangle represents the redeye as an object.

Referring back to FIG. 3A, color segmentation module 302 operates in a color space to separate pixels of input image 106 into two classes: red pixels and non-red pixels by using a separation boundary 308. In general, separation boundary 308 is a multi-dimensional surface that is defined within the color space that is used. And the surface separates the color space into two regions, which correspond to red pixels and non-red pixels respectively.

In many cases, however, it is not easy to design a scientific formulation of an optimal separation boundary 308 since it is not obvious how red is “red enough” for detecting redeye purpose. Although it is straightforward to model the distribution of redeye pixels within a color space by collecting a large number of redeye pixel samples and map them to the color space, the non-redeye pixel samples are not so easy to define and collect.

Referring to FIG. 4, one way to define and collect non-redeye pixels is through redeye pixel definition. Rectangle 312 represents a containing rectangle of a redeye region, which is defined in FIG. 3B. For training purpose, redeyes are manually labeled and represented using a containing rectangle for each. Pixels within each rectangle are considered as redeye pixel samples. To define non-redeye pixel samples, a neighboring region is defined by a rectangle 404, which is defined with respect to rectangle 312. In one embodiment, rectangle 404 shares the same center as rectangle 312 and has twice the side of rectangle 31 2.The dashed region 406 between rectangle 404 and 312 defines a neighboring region for redeye region 312. Pixels within region 406 are considered as non-redeye pixels. Experiments have determined that a good separation boundary should be optimal in separating the pixels in the neighboring region 406 from those inside redeye region 312.

Using the aforementioned definition, over 2000 of redeyes are manually labeled (represented using containing rectangles), and the redeye pixels and non-redeye pixels are defined respectively. Both redeye pixels and non-redeye pixels are mapped into a color space and the statistical distributions of the two classes are studied. Based on this analysis, it has been observed that it is easier to separate the two classes in luminance and chrominance color spaces such as YUV and CIE-LAB. However, it is also possible to design segmentation boundary in traditional RGB space. Since in most cases, color images are captured and stored in RGB space, doing segmentation directly in RGB space could save both CPU resources and system memory, which is highly desirable for applications running on embedded platforms.

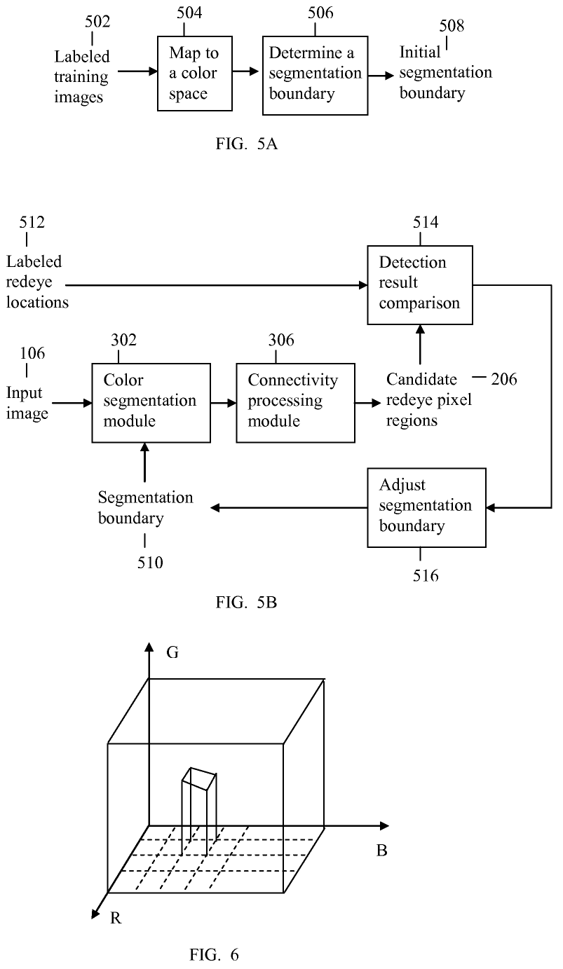

FIG. 5A and 5B illustrate a training procedure for determining the optimal segmentation boundary based on training data. Referring to FIG. 5A, first, a number of labeled images 502, that is, the training images with labeled redeye locations represented as containing rectangles, are collected. Using definitions described in FIG. 4, redeye pixels and non-redeye pixels are captured from labeled images and mapped to a color space (block 504). The statistical distributions of redeye pixels and non-redeye pixels within the color space are analyzed (block 506) and an initial segmentation boundary 508 is determined to minimize classification errors. In one implementation, color histogram is used to represent distributions and a segmentation boundary is determined based on color histograms of redeye pixels and non-redeye pixels.

Once an initial segmentation boundary 508 is determined, it is further refined using verification images through multiple iterations. Referring to FIG. 5B, initially, segmentation boundary 510 is initialized using segmentation boundary 508 from FIG. 5A. In each refining iteration, a verification image 106 is processed by a redeye candidate detection module (a color segmentation module 302, and followed by a connectivity processing module 306) to generated candidate redeye pixel regions 206. Note the segmentation by module 302 is controlled by segmentation boundary 510. Module 514 evaluates the errors in redeye candidate detection module by comparing the output candidate redeye pixel regions 206 with labeled redeye locations 512 (512 is provided as the ground truth for image 106 to the system. Note both 512 and 206 are represented as a group of containing rectangles). Any labeled redeye in 512 that is not detected in 206 is labeled as a miss error, but false alarms (the candidate redeye pixels regions that are in 206, but do not corresponds to any redeye label in 512) are ignored. Module 516 adjusts the segmentation boundary 510 based on the error information generated in module 514. This refining procedure is repeated multiple times until a stable segmentation boundary is obtained.

Note the training procedure illustrated in FIG. 5A and 5B is not dependent on any specific color space. In some embodiments, the segmentation boundary could be designed in RGB space. In some other embodiments, other color spaces such as CIE-LAB space and YUV color space could also be used by following the same training procedure.

In one embodiment, a segmentation boundary is designed in RGB color space by following the training procedure described in FIG. 5A and 5B. Ideally, a segmentation boundary in RGB space is a three dimensional surface. In some implementations, this three dimensional surface is approximated by a plural of piecewise planes in three dimension space. Referring to FIG. 6, in one implementation, RGB space is quantized along R and B axes respectively. This divides the R-B plane into a plural of rectangle meshes. If we denote the four corners of a mesh as (Rₘ, Bₙ), (Rₘ, Bₙ₊₁), (Rₘ₊₁, Bₙ), (Rₘ₊₁, Bₙ₊₁), where Rₘ and Rₘ₊₁ represent two consecutive quantized red values, and Bₙ and Bₙ₊₁ represent two consecutive quantized blue values, projecting the four corners of the mesh along G axis intercepts the ideal segmentation surface at four points in the three dimension space, which could be denoted as (Rₘ, Bₙ, Gₐ), (Rₘ, Bₙ₊₁, G_{b}), (Rₘ₊₁, Bₙ, G_{c}), (Rₘ₊₁, Bₙ₊₁, G_{d}). In some implementations, the small patch of the ideal segmentation surface that corresponds to mesh (Rₘ, Bₙ), (Rₘ, Bₙ₊₁), (Rₘ₊₁, Bₙ), (Rₘ₊₁, Bₙ₊₁) is approximated by two piecewise planes, one determined by 3 points of (Rₘ, Bₙ, Gₐ), (Rₘ, Bₙ₊₁, G_{b}), (Rₘ₊₁, Bₙ, G_{c}), and the other by (Rₘ, Bₙ, Gₐ), (Rₘ, Bₙ₊₁, G_{b}), (Rₘ₊₁, Bₙ₊₁, G_{d}). In accordance with this scheme, a segmentation surface in RGB space is determined by a plural of sampling points in the 3-d RGB space. And the segmentation boundary adjustment module 516 in FIG. 5B is instantiated as adjusting the positions of respective sampling points.

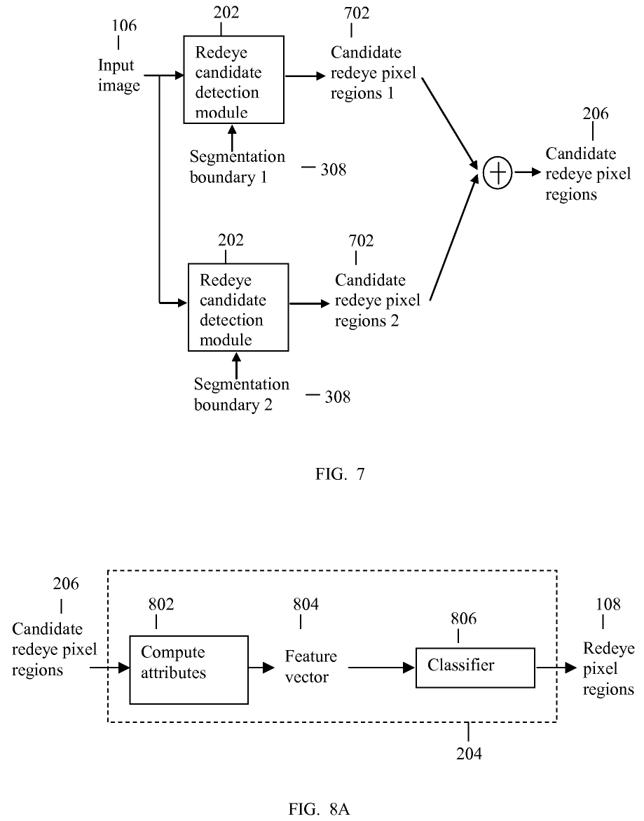

Referring to FIG. 7, in some implementations, a redeye candidate detection module 202 is repeated twice on a same input image 106 by using two different segmentation boundaries 308: a segmentation boundary 1 and a segmentation boundary 2. The candidate redeye pixel regions from the respective detection modules are merged to generate the final set of candidate redeye pixel regions. Note in this design, segmentation boundary 1 and 2 together provide better discrimination power for the candidate detection module. For example, in some implementations, a segmentation boundary 1 is designed to detect redeye pixels with colors that are very close to background pixels colors, such as reddish skin. In this case, the threshold value for redness has to be set high. In contrast, a segmentation boundary 2 is designed to detect redeye pixels that are weak in their redness feature. In this case, the threshold value for redness has to be set low. In general, because the statistical distributions of the redeye pixels and non-redeye pixels have considerable amount of overlapping, multiple segmentation boundaries could always provide better detection rate than single segmentation boundary. Although the final candidate redeye pixel regions 206 could be overly inclusive and includes more false alarms by using multiple segmentation boundaries, the down stream redeye verification module is designed to remove false alarms from redeye pixel regions with high accuracy, so that the false alarms generated in the redeye candidate detection module will be removed with high likelihood.

Referring to TABLE 1 and TABLE 2, two segmentation boundaries are illustrated for a preferred implementation in RGB space, in which the dynamic range of R, G, B are all [0,255]. In both tables, rows represent quantized red values and columns represent quantized blue values. Row and column together define a quantized mesh over R-B plane. The third dimension, green value is shown as the table entry. In other words, each table entry represents a sampling point of the segmentation boundary in the 3-d RGB space. The segmentation boundary is approximated using a plural of piecewise planes as described in FIG. 6. Referring back to FIG. 6, to segment a pixel, its color value is mapped to RGB space. It is segmented as a redeye pixel if it is below the segmentation boundary, and as non-redeye pixel otherwise. Note in TABLE 1 and TABLE 2, the quantized red value starts with 38 and 50 respectively. The rule of thumb is that anything with red value smaller than that is considered as non-redeye pixels.

Referring back to FIG. 7, segmentation boundary 1 is designed to detect redeye pixels with weak red values. Its numeric representation is described in TABLE 1. Segmentation boundary 2 is designed to detect redeye pixels with strong red values, but with weak contrast with its backgrounds. Its numeric representation is described in TABLE 2. Each redeye pixel region in candidate redeye pixel regions 1 and candidate redeye pixel regions 2 is represented using a containing rectangle and a support map (see FIG. 3B). The two sets of redeye pixel regions are merged to generate the final output set 206.

TABLE 1

| | BLUE | | | | | | | | | | | | | | | | |
|---|---|---|---|---|---|---|---|---|---|---|---|---|---|---|---|---|---|
| RED | 0 | 16 | 32 | 48 | 64 | 80 | 96 | 112 | 128 | 144 | 160 | 176 | 192 | 208 | 224 | 240 | 256 |
| 38 | 14 | 14 | 0 | 0 | 0 | 0 | 0 | 0 | 0 | 0 | 0 | 0 | 0 | 0 | 0 | 0 | 0 |
| 40 | 14 | 14 | 0 | 0 | 0 | 0 | 0 | 0 | 0 | 0 | 0 | 0 | 0 | 0 | 0 | 0 | 0 |
| 42 | 14 | 14 | 14 | 14 | 0 | 0 | 0 | 0 | 0 | 0 | 0 | 0 | 0 | 0 | 0 | 0 | 0 |
| 44 | 14 | 14 | 14 | 14 | 0 | 0 | 0 | 0 | 0 | 0 | 0 | 0 | 0 | 0 | 0 | 0 | 0 |
| 46 | 14 | 24 | 24 | 14 | 0 | 0 | 0 | 0 | 0 | 0 | 0 | 0 | 0 | 0 | 0 | 0 | 0 |
| 48 | 14 | 24 | 24 | 14 | 0 | 0 | 0 | 0 | 0 | 0 | 0 | 0 | 0 | 0 | 0 | 0 | 0 |
| 50 | 24 | 24 | 24 | 14 | 14 | 0 | 0 | 0 | 0 | 0 | 0 | 0 | 0 | 0 | 0 | 0 | 0 |
| 52 | 24 | 24 | 31 | 14 | 0 | 0 | 0 | 0 | 0 | 0 | 0 | 0 | 0 | 0 | 0 | 0 | 0 |
| 54 | 24 | 24 | 31 | 14 | 0 | 0 | 0 | 0 | 0 | 0 | 0 | 0 | 0 | 0 | 0 | 0 | 0 |
| 56 | 31 | 31 | 31 | 24 | 0 | 0 | 0 | 0 | 0 | 0 | 0 | 0 | 0 | 0 | 0 | 0 | 0 |
| 58 | 31 | 31 | 36 | 31 | 14 | 0 | 0 | 0 | 0 | 0 | 0 | 0 | 0 | 0 | 0 | 0 | 0 |
| 60 | 31 | 31 | 36 | 36 | 14 | 0 | 0 | 0 | 0 | 0 | 0 | 0 | 0 | 0 | 0 | 0 | 0 |
| 62 | 31 | 31 | 36 | 36 | 14 | 0 | 0 | 0 | 0 | 0 | 0 | 0 | 0 | 0 | 0 | 0 | 0 |
| 64 | 31 | 36 | 36 | 40 | 24 | 0 | 0 | 0 | 0 | 0 | 0 | 0 | 0 | 0 | 0 | 0 | 0 |
| 66 | 36 | 36 | 40 | 40 | 31 | 14 | 0 | 0 | 0 | 0 | 0 | 0 | 0 | 0 | 0 | 0 | 0 |
| 68 | 36 | 36 | 40 | 44 | 31 | 14 | 0 | 0 | 0 | 0 | 0 | 0 | 0 | 0 | 0 | 0 | 0 |
| 70 | 40 | 40 | 40 | 44 | 36 | 24 | 0 | 0 | 0 | 0 | 0 | 0 | 0 | 0 | 0 | 0 | 0 |
| 72 | 40 | 40 | 44 | 40 | 40 | 24 | 14 | 0 | 0 | 0 | 0 | 0 | 0 | 0 | 0 | 0 | 0 |
| 74 | 44 | 40 | 40 | 40 | 36 | 31 | 14 | 0 | 0 | 0 | 0 | 0 | 0 | 0 | 0 | 0 | 0 |
| 76 | 40 | 40 | 40 | 40 | 36 | 31 | 14 | 0 | 0 | 0 | 0 | 0 | 0 | 0 | 0 | 0 | 0 |
| 78 | 40 | 40 | 40 | 40 | 40 | 31 | 24 | 0 | 0 | 0 | 0 | 0 | 0 | 0 | 0 | 0 | 0 |
| 80 | 40 | 40 | 40 | 44 | 40 | 31 | 24 | 0 | 0 | 0 | 0 | 0 | 0 | 0 | 0 | 0 | 0 |
| 82 | 40 | 40 | 40 | 44 | 44 | 36 | 31 | 0 | 0 | 0 | 0 | 0 | 0 | 0 | 0 | 0 | 0 |
| 84 | 40 | 44 | 44 | 44 | 48 | 36 | 31 | 14 | 0 | 0 | 0 | 0 | 0 | 0 | 0 | 0 | 0 |
| 86 | 40 | 44 | 44 | 48 | 48 | 40 | 31 | 14 | 0 | 0 | 0 | 0 | 0 | 0 | 0 | 0 | 0 |
| 88 | 44 | 44 | 48 | 48 | 51 | 44 | 36 | 31 | 0 | 0 | 0 | 0 | 0 | 0 | 0 | 0 | 0 |
| 90 | 48 | 48 | 48 | 51 | 54 | 48 | 36 | 31 | 0 | 0 | 0 | 0 | 0 | 0 | 0 | 0 | 0 |
| 92 | 48 | 48 | 51 | 51 | 54 | 48 | 44 | 36 | 14 | 0 | 0 | 0 | 24 | 0 | 0 | 0 | 0 |
| 94 | 48 | 48 | 51 | 54 | 57 | 51 | 44 | 40 | 57 | 48 | 0 | 0 | 24 | 14 | 0 | 0 | 0 |
| 96 | 51 | 51 | 51 | 54 | 57 | 54 | 48 | 59 | 62 | 54 | 44 | 36 | 31 | 14 | 0 | 0 | 0 |
| 98 | 51 | 51 | 54 | 54 | 59 | 57 | 48 | 62 | 62 | 57 | 48 | 36 | 24 | 14 | 0 | 0 | 0 |
| 100 | 54 | 54 | 57 | 57 | 59 | 64 | 62 | 64 | 64 | 57 | 48 | 44 | 36 | 24 | 14 | 0 | 0 |
| 102 | 54 | 57 | 57 | 59 | 62 | 64 | 62 | 64 | 67 | 59 | 51 | 40 | 31 | 24 | 14 | 0 | 0 |
| 104 | 57 | 59 | 57 | 59 | 62 | 64 | 64 | 67 | 67 | 62 | 51 | 44 | 36 | 24 | 14 | 0 | 0 |
| 106 | 57 | 59 | 59 | 62 | 64 | 69 | 67 | 69 | 69 | 64 | 57 | 48 | 44 | 31 | 24 | 0 | 0 |
| 108 | 59 | 59 | 62 | 62 | 67 | 71 | 69 | 69 | 71 | 67 | 59 | 54 | 44 | 40 | 24 | 14 | 0 |
| 110 | 59 | 59 | 62 | 64 | 67 | 71 | 71 | 71 | 71 | 69 | 62 | 54 | 44 | 40 | 31 | 14 | 0 |
| 112 | 62 | 62 | 64 | 67 | 69 | 73 | 73 | 71 | 73 | 73 | 64 | 59 | 51 | 44 | 36 | 24 | 36 |
| 114 | 62 | 62 | 64 | 67 | 69 | 73 | 75 | 73 | 73 | 75 | 67 | 59 | 54 | 40 | 36 | 31 | 40 |
| 116 | 64 | 64 | 67 | 69 | 71 | 75 | 75 | 75 | 77 | 77 | 69 | 62 | 57 | 48 | 40 | 44 | 44 |
| 118 | 64 | 67 | 69 | 71 | 73 | 77 | 77 | 75 | 77 | 77 | 73 | 67 | 59 | 51 | 44 | 48 | 51 |
| 120 | 67 | 67 | 71 | 71 | 75 | 77 | 79 | 79 | 79 | 75 | 71 | 67 | 59 | 54 | 54 | 54 | 48 |
| 122 | 67 | 69 | 71 | 73 | 75 | 79 | 81 | 79 | 77 | 75 | 71 | 67 | 59 | 59 | 54 | 57 | 51 |
| 124 | 69 | 71 | 71 | 75 | 77 | 79 | 81 | 79 | 77 | 73 | 69 | 64 | 62 | 62 | 59 | 57 | 54 |
| 126 | 69 | 71 | 73 | 75 | 77 | 81 | 81 | 79 | 75 | 73 | 69 | 67 | 64 | 64 | 62 | 59 | 59 |
| 128 | 71 | 73 | 75 | 75 | 79 | 81 | 81 | 77 | 75 | 73 | 71 | 69 | 67 | 69 | 67 | 62 | 57 |
| 130 | 73 | 75 | 73 | 77 | 79 | 81 | 82 | 81 | 77 | 77 | 75 | 75 | 71 | 71 | 64 | 64 | 57 |
| 132 | 73 | 75 | 75 | 77 | 81 | 79 | 82 | 81 | 84 | 81 | 77 | 75 | 73 | 71 | 67 | 64 | 62 |
| 134 | 73 | 75 | 79 | 81 | 79 | 82 | 84 | 87 | 84 | 82 | 81 | 77 | 75 | 75 | 69 | 69 | 64 |
| 136 | 77 | 77 | 79 | 79 | 81 | 81 | 87 | 86 | 86 | 84 | 82 | 79 | 77 | 73 | 71 | 71 | 67 |
| 138 | 75 | 77 | 79 | 79 | 79 | 84 | 89 | 87 | 87 | 87 | 84 | 82 | 79 | 77 | 73 | 71 | 86 |
| 140 | 79 | 79 | 77 | 79 | 82 | 86 | 91 | 91 | 91 | 86 | 87 | 82 | 79 | 81 | 77 | 73 | 89 |
| 142 | 79 | 79 | 81 | 81 | 82 | 89 | 92 | 95 | 91 | 89 | 86 | 82 | 81 | 81 | 79 | 89 | 89 |
| 144 | 82 | 82 | 81 | 86 | 87 | 92 | 92 | 98 | 92 | 92 | 92 | 87 | 84 | 82 | 82 | 91 | 87 |
| 146 | 81 | 82 | 82 | 84 | 91 | 91 | 94 | 99 | 94 | 94 | 92 | 89 | 89 | 86 | 91 | 92 | 91 |
| 148 | 84 | 84 | 86 | 87 | 91 | 91 | 95 | 99 | 97 | 97 | 94 | 91 | 89 | 92 | 92 | 94 | 92 |
| 150 | 86 | 87 | 87 | 89 | 91 | 94 | 98 | 101 | 98 | 95 | 94 | 92 | 94 | 95 | 95 | 95 | 95 |
| 152 | 89 | 91 | 91 | 91 | 91 | 97 | 99 | 104 | 104 | 98 | 101 | 99 | 98 | 97 | 97 | 98 | 97 |
| 154 | 91 | 89 | 89 | 89 | 94 | 98 | 98 | 104 | 104 | 102 | 101 | 101 | 98 | 98 | 98 | 98 | 99 |
| 156 | 91 | 91 | 92 | 92 | 97 | 98 | 101 | 106 | 106 | 106 | 104 | 104 | 101 | 101 | 101 | 99 | 99 |
| 158 | 92 | 92 | 94 | 95 | 98 | 98 | 104 | 106 | 107 | 107 | 105 | 104 | 105 | 101 | 102 | 101 | 104 |
| 160 | 94 | 95 | 95 | 97 | 98 | 101 | 105 | 107 | 110 | 107 | 106 | 107 | 105 | 105 | 102 | 104 | 102 |
| 162 | 98 | 98 | 98 | 97 | 99 | 104 | 105 | 107 | 114 | 111 | 110 | 107 | 109 | 105 | 105 | 104 | 106 |
| 164 | 97 | 97 | 97 | 98 | 101 | 105 | 106 | 111 | 114 | 114 | 112 | 111 | 110 | 109 | 109 | 107 | 107 |
| 166 | 98 | 98 | 99 | 101 | 102 | 105 | 107 | 112 | 116 | 114 | 115 | 112 | 112 | 110 | 109 | 109 | 109 |
| 168 | 101 | 101 | 102 | 102 | 101 | 105 | 110 | 114 | 118 | 116 | 114 | 115 | 115 | 112 | 111 | 110 | 109 |
| 170 | 101 | 101 | 101 | 101 | 104 | 107 | 112 | 114 | 121 | 119 | 118 | 116 | 116 | 114 | 112 | 118 | 121 |
| 172 | 101 | 101 | 99 | 99 | 106 | 110 | 112 | 115 | 121 | 121 | 118 | 119 | 116 | 116 | 115 | 118 | 122 |
| 174 | 99 | 99 | 98 | 98 | 105 | 111 | 114 | 117 | 121 | 123 | 121 | 119 | 119 | 117 | 114 | 122 | 123 |
| 176 | 98 | 98 | 98 | 101 | 107 | 111 | 116 | 119 | 123 | 123 | 123 | 121 | 119 | 119 | 118 | 122 | 123 |
| 178 | 97 | 97 | 98 | 99 | 106 | 112 | 118 | 119 | 125 | 127 | 125 | 124 | 123 | 119 | 121 | 123 | 126 |
| 180 | 95 | 95 | 101 | 102 | 109 | 115 | 119 | 121 | 126 | 128 | 127 | 125 | 122 | 119 | 122 | 125 | 127 |
| 182 | 97 | 97 | 99 | 104 | 110 | 117 | 119 | 123 | 127 | 128 | 126 | 124 | 122 | 119 | 122 | 125 | 128 |
| 184 | 95 | 95 | 101 | 104 | 109 | 119 | 121 | 125 | 128 | 127 | 125 | 123 | 121 | 123 | 124 | 128 | 130 |
| 186 | 97 | 98 | 99 | 105 | 111 | 118 | 122 | 127 | 128 | 126 | 125 | 122 | 123 | 123 | 125 | 128 | 129 |
| 188 | 97 | 101 | 102 | 107 | 114 | 119 | 124 | 126 | 127 | 125 | 124 | 123 | 123 | 125 | 128 | 130 | 131 |
| 190 | 99 | 99 | 105 | 107 | 114 | 119 | 126 | 128 | 126 | 126 | 124 | 124 | 125 | 126 | 129 | 132 | 133 |
| 192 | 102 | 101 | 105 | 110 | 115 | 122 | 126 | 126 | 125 | 128 | 127 | 127 | 127 | 127 | 129 | 133 | 134 |
| 194 | 102 | 102 | 106 | 110 | 115 | 124 | 127 | 126 | 126 | 128 | 129 | 127 | 128 | 130 | 132 | 135 | 136 |
| 196 | 101 | 105 | 106 | 111 | 117 | 123 | 126 | 125 | 127 | 130 | 132 | 130 | 130 | 129 | 132 | 135 | 137 |
| 198 | 104 | 105 | 109 | 114 | 119 | 126 | 125 | 127 | 127 | 132 | 132 | 132 | 132 | 133 | 135 | 138 | 139 |
| 200 | 106 | 106 | 111 | 112 | 119 | 125 | 126 | 126 | 129 | 132 | 134 | 133 | 135 | 133 | 136 | 138 | 140 |
| 202 | 105 | 110 | 110 | 116 | 121 | 124 | 126 | 129 | 130 | 134 | 138 | 137 | 136 | 136 | 137 | 140 | 140 |
| 204 | 107 | 109 | 114 | 115 | 119 | 123 | 128 | 131 | 132 | 136 | 137 | 136 | 139 | 138 | 139 | 141 | 143 |
| 206 | 111 | 111 | 112 | 117 | 123 | 125 | 131 | 131 | 131 | 137 | 141 | 140 | 140 | 138 | 139 | 142 | 143 |
| 208 | 110 | 110 | 115 | 119 | 122 | 125 | 131 | 133 | 136 | 137 | 143 | 141 | 142 | 141 | 143 | 144 | 142 |
| 210 | 112 | 112 | 115 | 119 | 121 | 127 | 132 | 135 | 137 | 140 | 142 | 143 | 143 | 142 | 143 | 143 | 141 |
| 212 | 114 | 114 | 117 | 119 | 124 | 129 | 132 | 137 | 139 | 142 | 144 | 146 | 143 | 146 | 145 | 143 | 140 |
| 214 | 115 | 115 | 119 | 118 | 124 | 130 | 135 | 137 | 141 | 142 | 146 | 146 | 146 | 146 | 144 | 142 | 139 |
| 216 | 118 | 118 | 119 | 119 | 125 | 131 | 137 | 139 | 143 | 143 | 146 | 150 | 149 | 146 | 143 | 141 | 138 |
| 218 | 117 | 118 | 118 | 123 | 128 | 131 | 137 | 141 | 143 | 146 | 148 | 150 | 148 | 145 | 143 | 140 | 137 |
| 220 | 119 | 118 | 121 | 123 | 129 | 133 | 139 | 142 | 144 | 146 | 150 | 149 | 147 | 144 | 142 | 139 | 136 |
| 222 | 119 | 119 | 124 | 125 | 128 | 134 | 139 | 143 | 147 | 147 | 150 | 148 | 145 | 143 | 141 | 138 | 135 |
| 224 | 123 | 123 | 124 | 128 | 130 | 135 | 141 | 145 | 147 | 150 | 149 | 148 | 144 | 143 | 140 | 137 | 133 |
| 226 | 122 | 123 | 125 | 128 | 132 | 138 | 141 | 147 | 149 | 150 | 149 | 154 | 143 | 141 | 139 | 135 | 133 |
| 228 | 123 | 125 | 127 | 127 | 133 | 137 | 143 | 147 | 150 | 150 | 150 | 154 | 143 | 141 | 138 | 134 | 133 |
| 230 | 126 | 126 | 128 | 129 | 134 | 139 | 145 | 150 | 149 | 149 | 153 | 157 | 142 | 139 | 136 | 133 | 134 |
| 232 | 127 | 127 | 128 | 132 | 137 | 139 | 144 | 149 | 149 | 152 | 153 | 158 | 141 | 138 | 135 | 132 | 134 |
| 234 | 130 | 130 | 129 | 130 | 136 | 142 | 147 | 149 | 150 | 154 | 155 | 159 | 148 | 137 | 134 | 131 | 134 |
| 236 | 130 | 130 | 130 | 133 | 136 | 143 | 147 | 149 | 152 | 154 | 157 | 161 | 150 | 136 | 133 | 130 | 134 |
| 238 | 130 | 131 | 133 | 135 | 139 | 143 | 147 | 150 | 154 | 156 | 157 | 163 | 152 | 135 | 132 | 129 | 134 |
| 240 | 133 | 133 | 134 | 135 | 142 | 145 | 147 | 152 | 154 | 159 | 159 | 163 | 163 | 133 | 130 | 129 | 136 |
| 242 | 133 | 135 | 134 | 138 | 140 | 146 | 149 | 154 | 156 | 158 | 161 | 165 | 165 | 138 | 129 | 128 | 136 |
| 244 | 135 | 136 | 136 | 138 | 142 | 146 | 151 | 154 | 158 | 160 | 162 | 166 | 169 | 144 | 128 | 129 | 135 |
| 246 | 138 | 138 | 137 | 138 | 144 | 149 | 151 | 157 | 160 | 163 | 163 | 167 | 172 | 150 | 127 | 128 | 137 |
| 248 | 138 | 139 | 139 | 140 | 143 | 147 | 150 | 157 | 162 | 163 | 167 | 168 | 172 | 153 | 127 | 131 | 138 |
| 250 | 141 | 142 | 142 | 142 | 146 | 149 | 153 | 159 | 163 | 165 | 168 | 170 | 175 | 159 | 131 | 130 | 137 |
| 252 | 141 | 141 | 142 | 143 | 147 | 149 | 154 | 159 | 164 | 167 | 169 | 170 | 175 | 166 | 140 | 131 | 139 |
| 254 | 141 | 144 | 144 | 145 | 148 | 152 | 155 | 161 | 164 | 167 | 171 | 172 | 175 | 167 | 143 | 130 | 139 |

TABLE 2

| | BLUE | | | | | | | | | | | | | | | | |
|---|---|---|---|---|---|---|---|---|---|---|---|---|---|---|---|---|---|
| RED | 0 | 16 | 32 | 48 | 64 | 80 | 96 | 112 | 128 | 144 | 160 | 176 | 192 | 208 | 224 | 240 | 256 |
| 50 | 14 | 14 | 0 | 0 | 0 | 0 | 0 | 0 | 0 | 0 | 0 | 0 | 0 | 0 | 0 | 0 | 0 |
| 52 | 14 | 14 | 14 | 0 | 0 | 0 | 0 | 0 | 0 | 0 | 0 | 0 | 0 | 0 | 0 | 0 | 0 |
| 54 | 14 | 14 | 14 | 0 | 0 | 0 | 0 | 0 | 0 | 0 | 0 | 0 | 0 | 0 | 0 | 0 | 0 |
| 56 | 14 | 14 | 14 | 14 | 0 | 0 | 0 | 0 | 0 | 0 | 0 | 0 | 0 | 0 | 0 | 0 | 0 |
| 58 | 14 | 14 | 14 | 0 | 0 | 0 | 0 | 0 | 0 | 0 | 0 | 0 | 0 | 0 | 0 | 0 | 0 |
| 60 | 14 | 14 | 14 | 0 | 0 | 0 | 0 | 0 | 0 | 0 | 0 | 0 | 0 | 0 | 0 | 0 | 0 |
| 62 | 14 | 14 | 14 | 0 | 0 | 0 | 0 | 0 | 0 | 0 | 0 | 0 | 0 | 0 | 0 | 0 | 0 |
| 64 | 14 | 14 | 24 | 14 | 0 | 0 | 0 | 0 | 0 | 0 | 0 | 0 | 0 | 0 | 0 | 0 | 0 |
| 66 | 14 | 14 | 24 | 14 | 0 | 0 | 0 | 0 | 0 | 0 | 0 | 0 | 0 | 0 | 0 | 0 | 0 |
| 68 | 14 | 14 | 24 | 14 | 0 | 0 | 0 | 0 | 0 | 0 | 0 | 0 | 0 | 0 | 0 | 0 | 0 |
| 70 | 24 | 24 | 24 | 24 | 0 | 0 | 0 | 0 | 0 | 0 | 0 | 0 | 0 | 0 | 0 | 0 | 0 |
| 72 | 24 | 24 | 24 | 24 | 14 | 0 | 0 | 0 | 0 | 0 | 0 | 0 | 0 | 0 | 0 | 0 | 0 |
| 74 | 24 | 24 | 24 | 31 | 14 | 0 | 0 | 0 | 0 | 0 | 0 | 0 | 0 | 0 | 0 | 0 | 0 |
| 76 | 24 | 31 | 31 | 31 | 14 | 0 | 0 | 0 | 0 | 0 | 0 | 0 | 0 | 0 | 0 | 0 | 0 |
| 78 | 31 | 31 | 31 | 36 | 24 | 14 | 0 | 0 | 0 | 0 | 0 | 0 | 0 | 0 | 0 | 0 | 0 |
| 80 | 31 | 31 | 31 | 36 | 24 | 14 | 0 | 0 | 0 | 0 | 0 | 0 | 0 | 0 | 0 | 0 | 0 |
| 82 | 31 | 31 | 31 | 36 | 31 | 14 | 24 | 0 | 0 | 0 | 0 | 0 | 0 | 0 | 0 | 0 | 0 |
| 84 | 31 | 31 | 36 | 31 | 31 | 31 | 31 | 14 | 0 | 0 | 0 | 0 | 0 | 0 | 0 | 0 | 0 |
| 86 | 31 | 36 | 31 | 36 | 31 | 31 | 31 | 14 | 0 | 0 | 0 | 0 | 0 | 0 | 0 | 0 | 0 |
| 88 | 36 | 36 | 36 | 36 | 36 | 36 | 36 | 31 | 0 | 0 | 0 | 0 | 0 | 0 | 0 | 0 | 0 |
| 90 | 36 | 36 | 36 | 36 | 36 | 36 | 36 | 31 | 0 | 0 | 0 | 0 | 0 | 0 | 0 | 0 | 0 |
| 92 | 36 | 36 | 40 | 40 | 40 | 40 | 36 | 36 | 14 | 0 | 0 | 0 | 24 | 0 | 0 | 0 | 0 |
| 94 | 36 | 36 | 40 | 40 | 40 | 40 | 36 | 40 | 14 | 0 | 0 | 0 | 24 | 14 | 0 | 0 | 0 |
| 96 | 44 | 40 | 40 | 40 | 44 | 44 | 40 | 40 | 24 | 0 | 40 | 36 | 31 | 14 | 0 | 0 | 0 |
| 98 | 44 | 44 | 44 | 44 | 48 | 44 | 44 | 40 | 31 | 0 | 40 | 36 | 24 | 14 | 0 | 0 | 0 |
| 100 | 44 | 44 | 44 | 44 | 48 | 48 | 44 | 44 | 36 | 48 | 40 | 40 | 36 | 24 | 14 | 0 | 0 |
| 102 | 48 | 44 | 48 | 48 | 51 | 48 | 48 | 48 | 51 | 48 | 44 | 40 | 31 | 24 | 14 | 0 | 0 |
| 104 | 48 | 48 | 48 | 48 | 51 | 51 | 48 | 48 | 51 | 48 | 40 | 44 | 36 | 24 | 14 | 0 | 0 |
| 106 | 48 | 48 | 51 | 48 | 51 | 51 | 51 | 54 | 54 | 51 | 51 | 48 | 44 | 31 | 24 | 0 | 0 |
| 108 | 51 | 51 | 51 | 54 | 54 | 54 | 54 | 57 | 57 | 51 | 51 | 51 | 44 | 40 | 24 | 14 | 0 |
| 110 | 54 | 54 | 51 | 54 | 54 | 54 | 54 | 57 | 57 | 57 | 51 | 48 | 44 | 40 | 31 | 14 | 0 |
| 112 | 54 | 54 | 54 | 54 | 54 | 57 | 57 | 59 | 59 | 57 | 51 | 51 | 51 | 44 | 36 | 24 | 36 |
| 114 | 54 | 54 | 54 | 54 | 57 | 57 | 59 | 59 | 59 | 57 | 57 | 54 | 51 | 40 | 36 | 31 | 40 |
| 116 | 54 | 57 | 54 | 57 | 57 | 59 | 59 | 62 | 62 | 59 | 59 | 57 | 57 | 48 | 40 | 44 | 44 |
| 118 | 57 | 57 | 57 | 57 | 59 | 62 | 62 | 62 | 64 | 62 | 62 | 59 | 57 | 51 | 44 | 48 | 51 |
| 120 | 59 | 59 | 57 | 59 | 59 | 64 | 64 | 62 | 64 | 67 | 64 | 59 | 59 | 54 | 54 | 54 | 48 |
| 122 | 59 | 59 | 59 | 59 | 62 | 64 | 64 | 62 | 67 | 67 | 62 | 59 | 59 | 59 | 54 | 57 | 51 |
| 124 | 59 | 62 | 59 | 62 | 62 | 67 | 64 | 64 | 67 | 69 | 67 | 64 | 62 | 62 | 59 | 57 | 54 |
| 126 | 62 | 62 | 62 | 62 | 64 | 67 | 67 | 69 | 69 | 71 | 69 | 67 | 64 | 64 | 62 | 59 | 59 |
| 128 | 67 | 64 | 64 | 64 | 67 | 67 | 69 | 69 | 71 | 73 | 71 | 69 | 67 | 69 | 67 | 62 | 57 |
| 130 | 67 | 67 | 67 | 67 | 67 | 69 | 71 | 71 | 71 | 75 | 75 | 75 | 71 | 71 | 64 | 64 | 57 |
| 132 | 69 | 69 | 67 | 67 | 69 | 71 | 73 | 73 | 75 | 75 | 77 | 75 | 73 | 71 | 67 | 64 | 62 |
| 134 | 71 | 67 | 69 | 67 | 71 | 73 | 73 | 73 | 75 | 81 | 81 | 77 | 75 | 75 | 69 | 69 | 64 |
| 136 | 69 | 71 | 69 | 71 | 71 | 73 | 77 | 77 | 77 | 81 | 82 | 79 | 77 | 73 | 71 | 71 | 67 |
| 138 | 73 | 71 | 71 | 69 | 73 | 75 | 77 | 77 | 81 | 82 | 84 | 82 | 79 | 77 | 73 | 71 | 86 |
| 140 | 73 | 73 | 75 | 73 | 73 | 75 | 84 | 84 | 82 | 86 | 87 | 82 | 79 | 81 | 77 | 73 | 89 |
| 142 | 75 | 75 | 73 | 73 | 75 | 77 | 84 | 82 | 84 | 86 | 86 | 82 | 81 | 81 | 79 | 89 | 89 |
| 144 | 75 | 77 | 75 | 73 | 77 | 79 | 84 | 86 | 86 | 89 | 87 | 87 | 84 | 82 | 82 | 91 | 87 |
| 146 | 75 | 77 | 75 | 75 | 77 | 84 | 84 | 87 | 87 | 89 | 91 | 89 | 89 | 86 | 91 | 92 | 91 |
| 148 | 79 | 79 | 77 | 75 | 82 | 82 | 87 | 89 | 89 | 91 | 92 | 91 | 89 | 92 | 92 | 94 | 92 |
| 150 | 77 | 79 | 79 | 79 | 84 | 82 | 89 | 91 | 91 | 94 | 94 | 92 | 94 | 95 | 95 | 95 | 95 |
| 152 | 84 | 84 | 81 | 82 | 82 | 86 | 89 | 94 | 94 | 92 | 94 | 99 | 98 | 97 | 97 | 98 | 97 |
| 154 | 82 | 82 | 82 | 82 | 84 | 89 | 91 | 97 | 94 | 95 | 98 | 101 | 98 | 98 | 98 | 98 | 99 |
| 156 | 87 | 86 | 86 | 86 | 87 | 87 | 92 | 95 | 97 | 97 | 98 | 104 | 101 | 101 | 101 | 99 | 99 |
| 158 | 87 | 87 | 84 | 84 | 87 | 89 | 94 | 97 | 98 | 98 | 99 | 104 | 105 | 101 | 102 | 101 | 104 |
| 160 | 89 | 91 | 89 | 87 | 87 | 91 | 95 | 99 | 99 | 97 | 102 | 104 | 105 | 105 | 102 | 104 | 102 |
| 162 | 92 | 89 | 89 | 94 | 91 | 95 | 94 | 99 | 98 | 99 | 102 | 107 | 109 | 105 | 105 | 104 | 106 |
| 164 | 95 | 91 | 92 | 92 | 94 | 94 | 97 | 98 | 99 | 102 | 106 | 107 | 110 | 109 | 109 | 107 | 107 |
| 166 | 94 | 94 | 94 | 91 | 94 | 95 | 99 | 98 | 99 | 102 | 106 | 107 | 112 | 110 | 109 | 109 | 109 |
| 168 | 97 | 97 | 97 | 94 | 95 | 98 | 98 | 101 | 102 | 105 | 107 | 111 | 115 | 112 | 111 | 110 | 109 |
| 170 | 99 | 99 | 95 | 97 | 98 | 98 | 97 | 104 | 104 | 105 | 110 | 110 | 116 | 114 | 112 | 118 | 121 |
| 172 | 101 | 101 | 98 | 98 | 98 | 98 | 98 | 102 | 106 | 107 | 110 | 114 | 116 | 116 | 115 | 118 | 122 |
| 174 | 99 | 99 | 98 | 98 | 98 | 97 | 101 | 104 | 109 | 109 | 110 | 116 | 117 | 117 | 114 | 122 | 123 |
| 176 | 98 | 98 | 98 | 97 | 97 | 99 | 101 | 106 | 107 | 110 | 114 | 116 | 119 | 119 | 118 | 122 | 123 |
| 178 | 97 | 97 | 97 | 95 | 97 | 102 | 102 | 107 | 110 | 114 | 115 | 116 | 121 | 119 | 121 | 123 | 126 |
| 180 | 95 | 95 | 95 | 95 | 98 | 101 | 105 | 107 | 112 | 114 | 115 | 118 | 121 | 119 | 122 | 125 | 127 |
| 182 | 95 | 94 | 94 | 95 | 98 | 104 | 107 | 110 | 112 | 115 | 117 | 119 | 122 | 119 | 122 | 125 | 128 |
| 184 | 94 | 94 | 97 | 97 | 101 | 106 | 106 | 112 | 114 | 117 | 119 | 122 | 121 | 123 | 124 | 128 | 130 |
| 186 | 94 | 94 | 95 | 97 | 101 | 106 | 109 | 112 | 116 | 118 | 118 | 122 | 119 | 123 | 125 | 128 | 129 |
| 188 | 97 | 97 | 98 | 99 | 102 | 107 | 111 | 114 | 118 | 119 | 122 | 121 | 118 | 125 | 128 | 130 | 131 |
| 190 | 98 | 97 | 101 | 102 | 105 | 110 | 111 | 114 | 117 | 122 | 123 | 121 | 122 | 126 | 129 | 132 | 133 |
| 192 | 99 | 99 | 101 | 101 | 106 | 111 | 112 | 117 | 121 | 123 | 122 | 122 | 124 | 127 | 129 | 133 | 134 |
| 194 | 102 | 102 | 102 | 105 | 107 | 111 | 115 | 116 | 122 | 122 | 121 | 123 | 125 | 130 | 132 | 135 | 136 |
| 196 | 101 | 101 | 101 | 106 | 109 | 111 | 117 | 118 | 122 | 122 | 123 | 123 | 125 | 129 | 132 | 135 | 137 |
| 198 | 104 | 104 | 105 | 105 | 111 | 112 | 116 | 121 | 122 | 122 | 122 | 125 | 127 | 131 | 135 | 138 | 139 |
| 200 | 106 | 106 | 106 | 109 | 110 | 114 | 118 | 122 | 121 | 123 | 125 | 126 | 130 | 133 | 136 | 138 | 140 |
| 202 | 105 | 106 | 106 | 111 | 112 | 116 | 122 | 122 | 119 | 122 | 125 | 128 | 130 | 132 | 137 | 140 | 140 |
| 204 | 107 | 109 | 109 | 110 | 112 | 117 | 121 | 121 | 121 | 125 | 127 | 129 | 133 | 135 | 139 | 141 | 143 |
| 206 | 111 | 111 | 111 | 112 | 115 | 118 | 121 | 119 | 121 | 125 | 129 | 130 | 133 | 136 | 139 | 142 | 143 |
| 208 | 110 | 110 | 111 | 116 | 115 | 121 | 119 | 121 | 123 | 126 | 129 | 134 | 136 | 139 | 143 | 144 | 142 |
| 210 | 112 | 112 | 114 | 115 | 117 | 119 | 118 | 121 | 125 | 127 | 131 | 133 | 137 | 140 | 143 | 143 | 141 |
| 212 | 114 | 114 | 114 | 115 | 119 | 118 | 121 | 122 | 124 | 129 | 134 | 135 | 138 | 141 | 144 | 143 | 140 |
| 214 | 115 | 115 | 116 | 117 | 118 | 118 | 119 | 124 | 126 | 128 | 135 | 138 | 140 | 143 | 144 | 142 | 139 |
| 216 | 118 | 118 | 118 | 117 | 118 | 119 | 123 | 123 | 128 | 131 | 138 | 138 | 140 | 143 | 143 | 141 | 138 |
| 218 | 117 | 118 | 118 | 119 | 118 | 123 | 123 | 126 | 129 | 133 | 138 | 142 | 143 | 144 | 143 | 140 | 137 |
| 220 | 119 | 118 | 118 | 118 | 121 | 123 | 125 | 128 | 131 | 133 | 137 | 142 | 144 | 144 | 142 | 139 | 136 |
| 222 | 119 | 119 | 121 | 122 | 123 | 123 | 127 | 128 | 132 | 136 | 140 | 144 | 145 | 143 | 141 | 138 | 135 |
| 224 | 123 | 123 | 122 | 122 | 123 | 126 | 127 | 131 | 133 | 136 | 141 | 145 | 144 | 143 | 140 | 137 | 133 |
| 226 | 122 | 123 | 125 | 124 | 126 | 127 | 130 | 131 | 136 | 138 | 142 | 144 | 143 | 141 | 139 | 135 | 133 |
| 228 | 123 | 125 | 127 | 126 | 126 | 128 | 132 | 132 | 136 | 140 | 143 | 145 | 143 | 141 | 138 | 134 | 133 |
| 230 | 126 | 126 | 128 | 126 | 128 | 130 | 131 | 135 | 138 | 140 | 144 | 143 | 142 | 139 | 136 | 133 | 134 |
| 232 | 127 | 127 | 128 | 129 | 130 | 130 | 134 | 135 | 140 | 142 | 144 | 143 | 141 | 138 | 135 | 132 | 134 |
| 234 | 130 | 130 | 129 | 130 | 130 | 132 | 135 | 137 | 140 | 143 | 143 | 144 | 140 | 137 | 134 | 131 | 134 |
| 236 | 130 | 130 | 130 | 131 | 133 | 135 | 137 | 140 | 142 | 144 | 144 | 149 | 138 | 136 | 133 | 130 | 134 |
| 238 | 130 | 131 | 133 | 134 | 134 | 135 | 138 | 140 | 143 | 143 | 145 | 150 | 137 | 135 | 132 | 129 | 134 |
| 240 | 133 | 133 | 134 | 134 | 135 | 138 | 139 | 143 | 143 | 143 | 147 | 150 | 139 | 133 | 130 | 129 | 136 |
| 242 | 133 | 135 | 134 | 138 | 138 | 138 | 140 | 143 | 143 | 145 | 149 | 152 | 143 | 132 | 129 | 128 | 136 |
| 244 | 135 | 136 | 136 | 138 | 138 | 140 | 143 | 143 | 143 | 145 | 149 | 153 | 143 | 134 | 128 | 129 | 135 |
| 246 | 138 | 138 | 137 | 138 | 141 | 143 | 143 | 142 | 144 | 149 | 152 | 155 | 149 | 136 | 127 | 128 | 137 |
| 248 | 138 | 139 | 139 | 140 | 142 | 143 | 142 | 144 | 145 | 148 | 152 | 156 | 153 | 140 | 127 | 131 | 138 |
| 250 | 141 | 142 | 142 | 142 | 142 | 143 | 144 | 143 | 148 | 150 | 154 | 157 | 155 | 143 | 131 | 130 | 137 |
| 252 | 141 | 141 | 142 | 143 | 144 | 144 | 144 | 146 | 147 | 151 | 155 | 159 | 159 | 146 | 131 | 131 | 139 |
| 254 | 141 | 144 | 144 | 145 | 144 | 145 | 148 | 147 | 150 | 153 | 156 | 160 | 163 | 150 | 137 | 130 | 139 |

### B. Redeye Verification Module

Referring back to FIG. 2, a redeye verification module 204 takes a set of candidate redeye pixel regions 206 as input and reject those do not represent actual redeye detects (also referred to as non-redeye pixel regions or false alarms). The candidate redeye pixel regions that survive verification module 204 are sent to output 108 as redeye pixel regions.

### Basic Architechture

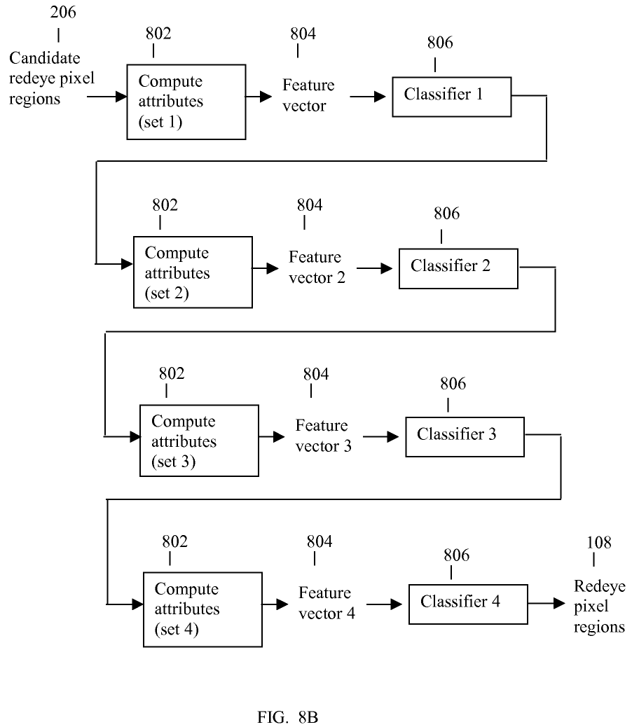

FIG. 8A shows an embodiment of redeye verification module 204 that includes an attribute computation module 802 and a classification module 806. The attribute computation module 802 computes multiple attributes or features of a candidate redeye pixel region to form a feature vector 804, and the feature vector 804 is further sent to classifier 806 to do binary classification. In general, a feature vector is represented as V=(v₁, v₂, . . . , vₙ), where V is a vector in a n-dimension space, and vₖ represents the k-th attributes computed (k=1, 2, . . . , n). Often, the classifier in classification module 806 is specified through a training process based on machine learning.

In practice, it has been observed that in order to get high accuracy in classification performance, the attribute computation module 802 has to compute a large number of attributes and the classification module 806 has in turn to process a feature vector of a very high dimension. For example, in one implementation, 1 50 attributes are needed for module 802 and 806 to generated sufficient classification performance. Referring back to FIG. 2, when the redeye candidate detection module 202 is designed to be inclusive and the size of the set of candidate redeye pixel regions 206 are big, the complexity of processing every candidate region in 206 using redeye verification module 204 with structure shown in FIG. 8A could be very high because about 1 50 attributes has to be computed and processed by a classifier for every candidate region. As explained in detail below, a cascaded architecture better suits redeye verification module 204.

FIG. 8B shows an exemplary embodiment of redeye verification module 204 that utilizes a cascaded architecture, which is comprised of four testing stages. At a k-th (k=1, 2, 3, 4) testing stage, an attribute computation module 802 computes a set of attributes {v₁(k), v₂(k), . . . vₙ₍ₖ₎(k)} of the input candidate redeye pixel region, where n(k) denotes the number of attributes computed for the k-th testing stage. The set of attributes is aggregated with attributes computed in the previous stages to form a feature vector 804 as

V(k)=(v₁(1), v₂(1), . . . vₙ₍₁₎(1), v₁(2), v₂(2), . . . vₙ₍₂₎(2), . . . , v₁(k), v₂(k), . . . vₙ₍ₖ₎(k)).

A classification module 806 processes feature vector 804 to generate a localized decision. An input candidate redeye pixel region is rejected if its feature vector 804 does not pass classification module 806. Otherwise, this candidate region is sent to a next stage for further processing. In the next stage, additional attributes are computed in module 802 to provide support for improved classification reliability by module 806. In accordance with this design, a candidate redeye pixel region has to pass all the classification modules 806 along the cascade in order to be identified as a redeye pixel region. Any candidate regions rejected by any classification modules are labeled as false alarms and dropped from further processing.

In some other embodiments, at a testing stage in a cascade, a feature vector 804 is defined by using only attributes computed in the same stage. If we denote a module 802 in a k-th stage computes a set of attributes as {v₁(k), v₂(k), . . . vₙ₍ₖ₎(k)}, then the feature vector 804 is defined as

V(k)=(v₁(k), v₂(k), . . . vₙ₍ₖ₎(k)).

In an appropriately designed cascade architecture shown in FIG. 8B, the testing stages in the front (i.e., stage 1 and 2) are often computationally inexpensive but efficient in rejecting easy to detect non-redeye pixel regions (false alarms). The testing stages in the rear (i.e., stage 3 and 4) are more complex and therefore more capable to detect challenging false alarms. As described previously, candidate redeye pixel regions 206 include much more non-redeye pixel regions (false alarms) than redeye pixel regions due to the inclusive nature of the redeye candidate detection module. In a cascade classification architecture, most candidate redeye pixel regions are rejected by early testing stages with relatively inexpensive computation cost, and very few survive to be processed by testing stages deeper in the cascade. Therefore the overall system complexity is greatly reduced as compared with an architecture described in FIG. 8A.

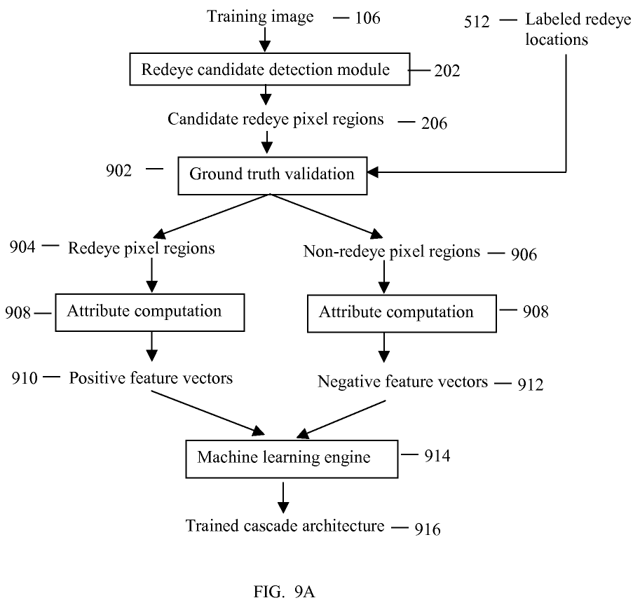

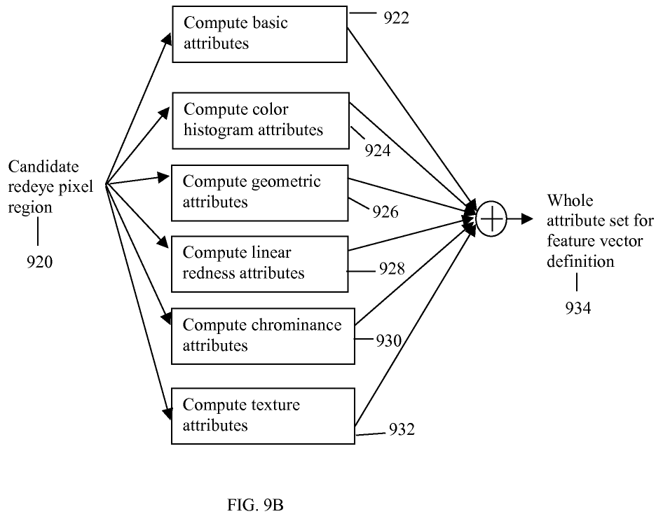

FIG. 9A shows a training procedure to build a cascade architecture illustrated in FIG. 8B. First, a set of training redeye images 106 is collected, together with labeled redeye locations 512 for each training image. Redeye candidate detection module 202 processes training images to produce a set of candidate redeye pixel regions 206. Ground truth validation module 902 validates the candidate redeye pixel regions 206 against labeled redeye locations 512 (which are considered as ground truth) and separates candidate regions 206 into two sets: redeye pixel regions 904 and non-redeye pixel regions 906. Both sets are further processed by a same attribute computation module 908 to compute a full list of attributes for each region in sets 904 and 906 respectively. For each region in region set 904, attributes computed by module 908 forms a feature vector. The feature vectors for all regions in 904 constitute a set 910 of positive feature vectors. Accordingly, a set 912 of negative feature vectors is generated from non-redeye pixel regions 906. Both sets of feature vectors 910 and 912 are fed to machine learning engine 914 to produce a trained cascade architecture 916.

### Attribute Design

In FIG. 9A, module 908 computes a whole set of attributes, which form a feature vector for each candidate redeye pixel region 206. In some embodiments, the attribute computation module 908 is intentionally designed to compute an overly inclusive set of attributes. In general, this set may contain any attributes that are considered possibly relevant to the classification of redeye pixel regions from non-redeye pixel regions. The selection of the attributes is delayed to the machine learning module 914.

FIG. 9B shows the block diagram of an embodiment of an attribute computation module 908, in which attributes are computed in several groups: basic attribute group (block 922), color histogram attribute group (block 924), geometric attribute group (block 926), linear redness attribute group (block 928), chrominance attribute group (block 930), and texture attribute group (block 932). The input candidate redeye pixel region 920 stands for redeye pixel regions 910 or non-redeye pixel regions 912 in FIG. 9A, while the output 934 is the whole set of attributes that is used to define the feature vectors 910 or 912 in FIG. 9A. The details about each attribute group and their computation blocks are described as follows. 68 Referring back to FIG. 3B, a candidate redeye pixel region is represented by a containing rectangle 312 and a support map 310. Attributes in a basic attribute group are comprised of (1) aspect ratio: the aspect ratio of containing rectangle 312, (2) the compactness: the ratio between the area of the support binary map 310 and the area of rectangle 312, (3) size ratio: the ratio between the area of rectangle 312 (in pixels) and the area of the input image (in pixels).

Geometric attribute group represents the geometric shape attributes of support binary map 310 using moment measures. It includes Hu's set of invariant moments I₁, I₂, . . . I₇, and their ratio: Iₙ/I₍ₙ₊₁₎, where n=1, 2, . . . , 6. For more information about Hu's moments, see M. K. Hu, Visual Pattern Recognition by Moment Invariants, IRE Trans. Info. Theory, vol. IT-8, pp. 179-187, 1962, which is incorporated herein as reference.

Color histogram attribute group is comprised of various histogram attributes of candidate redeye pixel region and its neighborhood. Referring to FIG. 4, in some embodiments, the color histogram of a neighborhood defined by rectangle 404 is measured as group attributes. The distribution of the color histogram is measured in 3 different color spaces: RGB space, CIE-LAB space, and YUV space. In each color space, a three-dimension color histogram is computed, with each axis component evenly divided into 4 bins. The histograms from the three color spaces are merged to form a group of attributes.

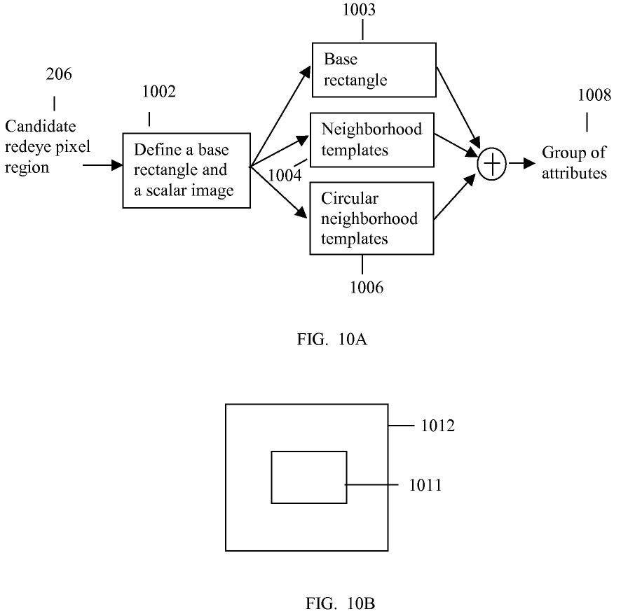

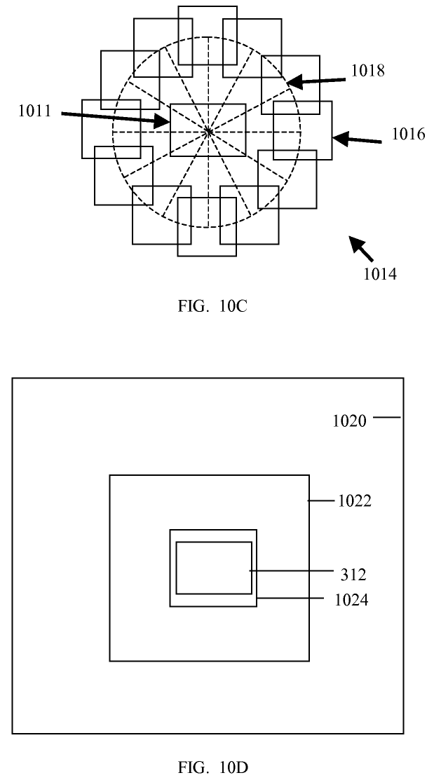

Chrominance attribute group, linear redness attribute group and texture attribute group are similar in definition. FIG. 10A shows a block diagram of the processing procedure that could be used to compute all three attribute groups. Given an input candidate redeye pixel region 206, block 1002 defines a base rectangle and a scalar image based on the specific attribute group being computed. Once a base rectangle and a scalar image are determined, contrast attributes are computed in three blocks: block 1003 is based on the base rectangle, block 1004 is based on a scalable neighborhood template, and block 1006 is based on a scalable circular neighborhood template. Their respective outputs are merge to form the final output 1008.

FIG. 10B shows a base rectangle 1011 and a neighborhood rectangle 1012, which are used by block 1003 and block 1004.

Block 1003 computes statistical distribution measures of the scalar image within the base rectangle 1011. In some implementations, attributes computed including:
(1) min(base), the minimal pixel scalar value for pixels within 1011;
(2) max(base), the maximal pixel scalar value for pixels within 1011;
(3) range(base)=max(base)−min(base), the dynamic range of pixel scalar value;
(4) std(base), the standard deviation of pixel scalar value;

Referring to FIG. 10B, a neighborhood template 1012 is defined with respect to a base rectangle 1011. In some implementations, a neighborhood template 1012 is a square with side d(ne), and centered at the same center of base rectangle 1011. The side of 1012 is defined as d(ne)=α(a+b)/2, where a, b are the length of the two sides of base rectangle 1011, and α is a scaling factor. Given a scaling factor α, a neighborhood template 1012 defines a neighborhood region on the corresponding scalar image, for which the following attributes are computes:
(1) contrast=mean(ne)−mean(base), where mean(ne) and mean(base) are the average pixel scalar value of pixels within neighborhood rectangle 1012 and within base rectangle 1011, respectively;
(2) normalized_contrast=[mean(ne)−mean(base)]/mean(base);
(3) min(ne), the minimal pixel scalar value for pixels within 1012;
(4) normalized_min(ne)=min(ne)/mean(base);
(5) max(ne), the maximal pixel scalar value for pixels within 1012;
(6) normalized_max(ne)=max(ne)/mean(base);
(7) range(ne)=max(ne)−min(ne), the dynamic range of pixel scalar value;
(8) normalized_range(ne)=range(ne)/mean(base);
(9) std(ne), the standard deviation of pixel scalar value;
(10) normalized_std(ne)=std(ne)/mean(base).
   Note above attributes (1)-(10) are all based on two rectangles 1012 and 1011, which define regions on a scalar image, and the statistics of pixels of this scalar image within these two rectangles are computed as attributes. Referring back to FIG. 10A, in some implementations, block 1004 sets the scaling factor ox to values of {1, 1.2, 1.3, 1.5, 2, 2.5}, which defines 6 different neighborhood templates 1012. For each of the template, the aforementioned attributes (1)-(10) are computed, and they together generate 60 attributes for the group.

Referring to FIG. 10C, a circular neighborhood template 1014 is defined with respect to a base rectangle 1011. In some implementations, a circular neighborhood template 1014 is comprised of 12 circular squares 1016 whose centers evenly located on a neighborhood circle 1018, and each with a same side d(ce). Note the neighborhood circle 1018 shares the same center with base rectangle 1011, and has a radius of r(ce). A circular neighborhood template 1014 has two scaling factors, β and γ, which control d(ce) and r(ce) respectively as follows:

d(ce)=β(a+b)/2;

r(ce)=(a+b)/2;

Given a fixed set of scaling factor (β, γ), a circular neighborhood template 1014 defines a set of neighborhood regions on the corresponding scalar image, for which the following attributes are computed:
(1) min(ce)=minₖ₌₍₀₋₁₁₎ (mean(ce, k)−mean(base)), where mean(ce,k) and mean(base) are the average pixel scalar value of pixels within the k-th circular square 1016 and within the base rectangle 1011 respectively. In other words, min(ce) is the minimal contrast between 12 circular squares and the base rectangle;
(2) normalized_min(ce)=min(ce)/mean(base);
(3) max(ce)=maxₖ₌₍₀₋₁₁₎ (mean(ce, k)−mean(base));
(4) normalized_max(ce)=max(ce)/mean(base);
(5) min(ce, n)=minₖ₌₍₀₋₁₁₎ (mean(ce, k, n)−mean(base)), where

mean(ce, k, n)=[Σₘ₌₍₁₋ₙ₎ mean(ce,(k+m−1 mod 12))/n,

that is, mean(ce, k, n) is an average of the means of n consecutive circular squares, and n is the length of an average filter;
(6) normalized_min(ce, n)=min(ce, n)/mean(base);
(7) max(ce, n)=maxₖ₌₍₀₋₁₁₎ (mean(ce, k, n)−mean(base));
(8) normalized_max(ce, n)=max(ce, n)/mean(base);
(9) max_cr(ce)=maxₖ₌₍₀₋₁₁₎ [(mean(ce, k)+mean(ce, (k+6 mod 12))−mean(ce, (k+3 mod 12))−mean(ce, (k+9 mod 12))];
(10) normalized_max_cr(ce)=max_cr(ce)/mean(base);
(11) min_cr(ce)=minₖ₌₍₀₋₁₁₎ [(mean(ce, k)+mean(ce, (k+6 mod 12))−mean(ce, (k+3 mod 12))−mean(ce, (k+9 mod 12))];
(12) normalized_min_cr(ce)=min_cr(ce)/mean(base);
   In some implementations, the n value in attributes (5)-(8) is selected to be {1, 2, 3, 4}. Therefore each circular neighborhood template generates 48 attributes. Referring back to FIG. 10A, In some implementations, block 1006 sets the scaling factor (β, γ) to values of {(0.8, 1.1), (0.8, 1.2), (0.8, 1.3), (1, 1.1), (1, 1.2), (1, 1.3)}, which defines 6 different circular neighborhood templates. For each of the template, the aforementioned attributes (1)-(12) are computed, and they together generate 288 attributes.

Referring to FIG. 10A, to compute linear redness attributes, in some embodiments, module 1002 defines a base rectangle (FIG. 10B, 1011) using the containing rectangle of a candidate redeye pixel region (see FIG. 3B, 312). And a scalar image is computed by defining a linear redness measure as

LR=160*(4*R−3*G+B)/(3*R+4*G+3*B+1).

Note LR is a scalar value defined for each pixel in input image, therefore LR defines a scalar image based on the input image. Given the base rectangle and scalar image definition, blocks 1003, 1004 and 1006 are applied to generate linear redness attribute group 1008.

Similarly, to compute chrominance attributes, in some embodiments, a base rectangle is defined using the containing rectangle of a candidate redeye pixel region (see FIG. 3B, 312) in module 1002. And a scalar image is computed by converting the input image from RGB space into CIE-LAB space, and taking the a* component. The same blocks 1003, 1004 and 1006 are further applied to generate chrominance attribute group 1008.

In some embodiments, the processing procedure shown in FIG. 10A is also used to compute texture attributes. The scalar image used in this case is the grayscale image, defined by grayscale measure: grayscale=0.299R+0.587G+0.114B. The base rectangle is determined by a searching process described as follows.

Referring to FIG. 10D, a base rectangle 1024 for computing texture attribute group is assumed to be a square, which is used to model an eyeball. Normally an eyeball square is a square that is much darker than its surrounding areas. To identify the location of this square, first a searching square 1020 is defined. In some implementations, the square 1020 is assumed to share same center with redeye pixel region containing rectangle 312, and has a side d(search)=7*(a+b)/2, where a, and b are length of two sides of rectangle 312. An eyeball square is detected using a scalable search template including two squares 1022 and 1024, both centered at the center of rectangle 312, and inner square 1024 having half the side length of outer square 1022. In a typical searching process, the template is initialized by setting its inner square side as (a+b)/2, and then increased by step of one until its outer square goes outside of search square 1020. The final eyeball square is determined as the inner square 1024 of a search template that generates the highest grayscale contrast between square 1024 and square 1022.

### Cascade Architecture Design

Referring back to FIG. 9A, in some embodiments, the machine learning module 91 4 is based on Adaboost machine learning technology. Because it is known in the art that Adaboost learning engine could be configured to do feature selection and classifier training simultaneously, the attribute computation module 908 described above is intentionally designed to compute an overly inclusive set of attributes. The selection of the attributes is delayed to the machine learning module 914.

Adaboost is a well-known technology in the literature. For example, P. Viola and M. Jones describes a method of designing a cascade of classifiers using Adaboost for detecting human faces from images (see P. Viola and M. Jones, Rapid object detection using a boosted cascade of simple features, 2001 International Conference on Computer Vision and Pattern Recognition, which is incorporated herein by reference). The method proposed by Viola and Jones could be used for machine learning module 914.

In some preferred embodiments, however, some improved Adaboost algorithm is used to build a cascade of classifiers, which is described in more details as follows. Referring to FIG. 9A, if we denote a training feature vector from 910 and 912 as V=(v₁, v₂, . . . , vₙ), a training sample is comprised of a feature vector V and a ground truth label y, where y=1 if the training sample is from 910 and y=−1 if it is from 912. The whole set of training samples is thus represented as S={(V(1), y(1)), V(2), y(2)), . . . , (V(m), y(m))}, where (V(k), y(k))εν×{−1,1}, and ν represents a n-dimension feature space to which a feature vector V=(v₁, v₂, . . . , vₙ) belongs. An improved Adaboost algorithm is described as follows.
Input: a set of training samples S={(V(1), y(1)), (V(2), y(2)), . . . , (V(m), y(m))}, and desired number of weak classifiers T to include in the final boosted classifier.
Initialize the sample distribution D₁(i)=1/m.
For t=1, . . . , T:
   For each weak classifier hᵢ, (i=1, 2, . . . , n) do:
      Partition feature space ν into K disjoint regions: ν₁, ν₂, . . . νₖ. Note in this implementation, the partition of feature space ν for weak classifier hᵢ is realized by evenly dividing the range of the i-th feature vᵢ into K bins. Normally vi is normalized to range of [0,1] and the K bins is evenly defined over this range. This way, weak classifier hᵢ is tied up with feature vᵢ.
      Under the distribute Dₜ, compute

$${W}_{j} ( l ) = {\sum }_{i : ( ( V ( i ) ∈ {𝒱}_{j} ) ⋂ ( y ( i ) = l ) )} {D}_{t} ( i ) ,$$

where l=±1.
Set the output of weak classifier hᵢ as

$$∀ V ∈ {𝒱}_{j} , {h}_{i} ( V ) = ln ( \frac{{W}_{j} ( + 1 ) + e}{{W}_{j} ( - 1 ) + e} ) ,$$

where e is a small constant.
Compute a normalization factor Z, with

$$Z = {\sum }_{j} 2 \sqrt{{W}_{j} ( + 1 ) {W}_{j} ( - 1 )} .$$

Select the hₜ as the weak classifier hᵢ (i=1, 2, . . . , n) that minimize Z.
Update the sample distribution Dₜ₊₁(i)=Dₜ(i)exp [−y(i)hₜ(V(i))]
The final boosted classifier H is

$$H ( V ) = sign [ {\sum }_{t = 1}^{T} {h}_{t} ( V ) - b ] ,$$

where b is a bias threshold whose default value is zero. Generally one can use b to control trade-off between detection rate and false alarm rate.

Note in above algorithm, the final boosted classifier H( ) contains T weak classifiers hₜ( ), and each weak classifier hₜ( ) is only dependent on one input feature (the feature that defines its partition). Therefore this training procedure not only generates a classification function H( ), but also selects the features that are necessary to drive H( ).

Referring back to FIG. 8B, using the Adaboost algorithm described above, a cascade architecture could be build straight-forwardly. In one implementation, the four testing stages shown in FIG. 8B are built by the following steps. (1) Determine the number of features to compute for each testing stage, i.e., the T value for Adaboost training. Based on the reasons mentioned previously, the T values for four stages are selected heuristically to be 6, 15, 20, 30, i.e., fewer features are computed in earlier stages, and more features in later stages. (2) Train the first stage by following the Adaboost algorithm described above, setting T=6. To reduce the system complexity, only features correspond to the attributes belonging to linear redness group and basic group are allowed to be used by Adaboost algorithm. Once the best 6 features are selected, adjust the bias value b so that the detection rate is better than 98% over some validation data set. (3) Train the second stage by using only training samples that pass the first stages, and setting T=15. Adaboost algorithm is allowed to use the features correspond to the attributes belonging to linear redness group, basic group, and texture group. Set the bias value b to make sure stage-wise detection rate is better than 98%. (4) Train the third stage by using only training samples that pass the first two stages, and setting T=20. Adaboost algorithm is allowed to use the features correspond to the attributes belonging to linear redness group, basic group, texture group and color histogram group. Set the bias value b to make sure stage-wise detection rate is better than 98%. (5) Train the last stage by using only training samples that pass the first three stages, and setting T=30. Adaboost algorithm is allowed to use all the features. Adjust the bias value b for the last stage to achieve the desired trade-off of detection rate and false alarm rate.

Note in FIG. 8B, the attribute computation module 802 at each stage computes only the attributes that are necessary for driving the classification module 806 in the same stage. The specific attributes to compute for each stage are known through Adaboost training, and they are all subsets of the whole set of attributes computed in the training stage by module 908 in FIG. 9A. In other words, although module 908 used in training computes a very large set of features, the modules 802 in the cascade architecture compute only a small subset of them. In addition, by aggregating the attributes into groups and imposing group limitation at Adaboost training stage, module 802 is computationally more efficient. For example, by using the training procedure described above, module 802 for the first stage computes only the attributes in basic group and linear redness group, in the second stage, the attributes in texture group are computed, and in the third stage, the attributes in color histogram group is computed, and the rest attributes are computed in the last stage.

### III. Redeye Correction Module

Referring back to FIG. 1, redeye correction module 104 processes each detected redeye pixel region 108 to actually remove redeye detects.

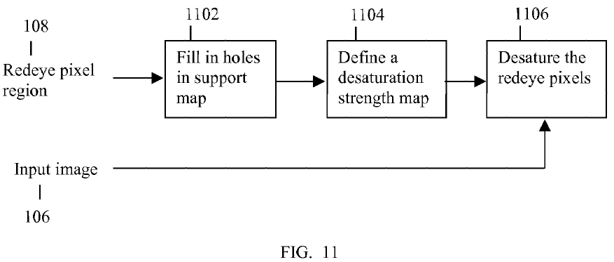

FIG. 11 shows an embodiment of redeye correction module including a hole-filling block 1102, a desaturation strength computing block 1104 and a desaturation block 1106. First, block 1102 processes the support map of a detected redeye pixel region using morphological filters to fill in holes in the support map (see FIG. 3B, 310). Second, a desaturation strength map is defined by block 1104 based on the filtered support map from block 1102, and at last desaturation block 1106 desaturates input image pixels located within the containing rectangle 312 using the following equations:

R(x,y)=R(x,y)*(1−de_strength(x,y))+de_strength(x,y)*Gray(x,y),

G(x,y)=G(x,y)*(1−de_strength(x,y))+de_strength(x,y)*Gray(x,y),

B(x,y)=B(x,y)*(1−de_strength(x,y))+de_strength(x,y)*Gray(x,y),

where R(x,y), G(x,y), B(x,y) represent the R,G,B values of input image pixel at location (x,y), and de_strength(x,y) is the desaturation strength map value at location (x,y).

In some implementations, a desaturation map is defined by block 1104 for each redeye pixel region as follows. For each pixel in containing rectangle 312 (see FIG. 3B), its initial desaturation strength (de_strength) is set to 0 if its support map is 0 and 1 if its support map is 1. The initial strength map is filtered by a 5 by 5 average filter (padding if necessary), followed by a shifting operation:

de_strength=de_strength*0.9+0.2.

After that, de_strength is clipped to the range of [0,1].

What is claimed is:

1. A method for processing an input digital image, comprising:
defining at least one segmentation surface that segments a color space into at least two regions;
segmenting pixels of the input image based on mapping of color values of the pixels into the color space and identifying the relative positions of the pixels in the color space with respect to the at least one segmentation surface; and
identifying candidate redeye pixel regions in the input image based on the segmented pixels of the input image.

2. The method of claim 1, wherein the color space used for segmentation is RGB color space.

3. The method of claim 1, wherein the candidate redeye pixel regions are identified by using pixel connectivity.

4. The method of claim 1, wherein the at least one segmentation surface is approximated by a plural of segmentation planes controlled by a plural of sampling points.

5. The method of claim 4, wherein the plural of sampling points are defined by quantizing at least one axis of the color space.

6. The method of claim 1, wherein the pixels are segmented by using a first segmentation surface and a second segmentation surface.

7. The method of claim 6, wherein a first set of candidate redeye pixel regions is identified based on the first segmentation surface, and a second set of candidate redeye pixel regions is identified based on the second segmentation surface, and the candidate redeye pixel regions are merged into a set of candidate redeye pixel regions.

8. A method for detecting redeye pixel regions from an input digital image, comprising: (a) identifying a set of candidate redeye pixel regions in the input digital image; (b) verifying each candidate redeye pixel region in said set using a cascade of stage-wise testing steps each including (i) computing a set of attributes from the input digital image, (ii) defining a feature vector using said set of attributes, (iii) processing said feature vector with a classifier, and (iv) rejecting a said candidate redeye pixel region or keeping a said candidate redeye pixel region for processing by a next testing step based on output of said classifier; (c) recording candidate redeye pixel regions from said set that survive verifying as redeye pixel regions.

9. The method of claim 8, wherein said feature vector is defined by combining said set of attributes with attributes computed in previous stage-wise testing steps in said cascade.

10. The method of claim 8, wherein said cascade of stage-wise testing steps are designed using machine learning technology.

11. The method of claim 8, wherein said cascade of stage-wise testing steps are designed such that the testing steps in the front are computationally inexpensive and the testing steps in the rear are computationally more expensive.

12. The method of claim 8, wherein at least some attributes computed by said cascade are based on computing moments of each said candidate redeye pixel region.

13. The method of claim 8, wherein at least some attributes computed by said cascade are based on computing color histogram of each said candidate redeye region and its neighborhood.

14. The method of claim 8, wherein at least some attributes are computed by applying a set of templates to a scalar image.

15. The method of claim 14, wherein said set of templates includes a base rectangle, and some attributes are computed by identifying the dynamic range of said scalar image within said base rectangle.

16. The method of claim 14, wherein said set of templates includes a scalable neighborhood template defined with respect to a base rectangle, and some attributes are computed by identifying the contrast of said scalar image between said neighborhood template and said base rectangle.

17. The method of claim 14, wherein said set of templates includes a scalable circular neighborhood template, said circular neighborhood template being defined with a plural of same size rectangles A with centers evenly located on a circle B, said rectangles A and said circle B being both defined with respect to a base rectangle C.

18. The method of claim 17, wherein some attributes are computed by identifying an extrema of contrasts of said scalar image between said base rectangle C and said plural of rectangles A.

19. The method of claim 18, wherein said contrasts are computed by (i) computing mean values of scalar image within said plural of rectangles A; (ii) filtering said mean values using a circular averaging filter; (iii) determining said contrasts based on said filtered mean values and mean value of said scalar image within said base rectangle.

20. The method of claim 14, wherein said scalar image is a linear redness image.

21. The method of claim 14, wherein said scalar image is defined by a chrominance component of a chrominance-luminance color space.

22. The method of claim 14, wherein said scalar image is a grayscale image.

23. A system of processing an input digital image, comprising a redeye detection module operable to: (a) identify a set of candidate redeye pixel regions in the input digital image; (b) verify each candidate redeye pixel region in said set using a cascade of stage-wise testing steps each including (i) computing a set of attributes from the input digital image, (ii) defining a feature vector using said set of attributes, (iii) processing said feature vector with a classifier, and (iv) rejecting a said candidate redeye pixel region or keeping a said candidate redeye pixel region for processing by a next testing step based on output of said classifier; (c) record candidate redeye pixel regions from said set that survive verifying as redeye pixel regions.
